(19) United States
(12) Patent Application Publication
(10) Pub. No.: US 2014/0063120 A1
(43) Pub. Date: Mar. 6, 2014

(54) NOZZLE CLEANING MECHANISM OF INKJET PRINTING DEVICE

(71) Applicant: PRIMAX ELECTRONICS LTD., Taipei (TW)

(72) Inventors: Tung-Wen Tu, Taipei (TW); Yan-Hua Li, Taipei (TW)

(73) Assignee: PRIMAX ELECTRONICS LTD., Taipei (TW)

(21) Appl. No.: 13/737,274

(22) Filed: Jan. 9, 2013

(30) Foreign Application Priority Data
Aug. 31, 2012 (CN) 201210319719.2

(51) Int. Cl. B41J 2/165

(52) U.S. Cl. CPC B41J 2/1652
USPC 347/30

(57) ABSTRACT

A nozzle cleaning mechanism of an inkjet printing device includes an ink pump, plural ducts, and a switching module. The ink pump is used for generating a suction force. The plural ducts are connected with the ink pump and corresponding plural print heads. The switching module is used for controlling open/close statues of the plural ducts. For cleaning a first nozzle of a first print head by the nozzle cleaning mechanism, the first duct is corresponding to the first print head is controlled to be in the open status by the switching module. Consequently, the first nozzle is cleaned in response to the suction force. At the same time, the other ducts are in the close status.

### FIELD OF THE INVENTION

The present invention relates to a nozzle cleaning mechanism, and more particularly to a nozzle cleaning mechanism of an inkjet printing device.

### BACKGROUND OF THE INVENTION

A printing device is a peripheral device of a computer. Generally, the printing device is in communication with the computer. By operating the computer, a document electronic file stored in the computer may be printed on a paper through the printing device. Consequently, a paper document corresponding to document electronic file may be printed out by the printing device. The document electronic file is a text file or an image file. Moreover, an inkjet printing device is a printing device that uses ink as the printing material.

FIG. 1 is a schematic perspective view illustrating the outward appearance of a conventional inkjet printing device. As shown in FIG. 1, the inkjet printing device 1 comprises a print head 10, a first ink cartridge 11, a second ink cartridge 12, a transmission mechanism 13, a paper input tray 14, and a paper output tray 15. The first ink cartridge 11 is used for storing a first ink (not shown). The second ink cartridge 12 is located beside the first ink cartridge 11 for storing a second ink (not shown). For example, the first ink is a black ink, and the second ink is a color ink. The print head 10 comprises a first nozzle (not shown) and a second nozzle (not shown). The print head 10 is connected with the first ink cartridge 11 and the second ink cartridge 12. Consequently, the first ink and the second ink may be ejected out of the print head 10 through the first nozzle and the second nozzle, respectively. The transmission mechanism 13 is connected with the print head 10. The transmission mechanism 13 is driven to move the print head 10, so that the first ink or the second ink may be ejected out and printed on any position of a blank paper P. The paper input tray 14 is used for placing the blank paper P thereon. After an inkjet printing operation is performed, the paper P is exited to the paper output tray 15.

During the inkjet printing operation of the conventional inkjet printing device 1 is performed, the blank paper P on the paper input tray 14 is fed into the inkjet printing device 1 in a feeding direction Y by a feeding mechanism (not shown), and the print head 10 is moved in a printing direction X by the transmission mechanism 13. The printing direction X is perpendicular to the feeding direction Y. After the inkjet printing operation is completed, the paper P is exited to the paper output tray 15. The structures of the conventional inkjet printing device 1 and the printing process thereof have been mentioned above. However, if the inkjet printing operation is repeatedly performed by the conventional inkjet printing device 1, the first nozzle and the second nozzle of the print head 10 are readily clogged. In a case that the first nozzle and the second nozzle are clogged by dust, foreign matter or bubble, the print head 10 fails to eject ink. For solving the drawbacks, the inkjet printing device is usually equipped with a nozzle cleaning mechanism for preventing from occurrence of the clogged condition of the nozzle.

Hereinafter, the structures of a nozzle cleaning mechanism of a conventional inkjet printing device will be illustrated with reference to FIG. 2. FIG. 2 is a schematic perspective view illustrating a nozzle cleaning mechanism of a conventional inkjet printing device. The nozzle cleaning mechanism 16 is disposed within the conventional inkjet printing device 1 for eliminating the clogged conditions of the first nozzle and the second nozzle. As shown in FIG. 2, the nozzle cleaning mechanism 16 comprises an ink pump 161, a connecting cover 162, a first duct 163, a second duct 164, a first discharge pipe 165, a second discharge pipe 166, and a storage element 167. The connecting cover 162 is connected with a first end 1631 of the first duct 163 and a first end 1641 of the second duct 164. The connecting cover 162 may be moved to a position to be contacted with the print head 10, so that the first nozzle and second nozzle are covered by the connecting cover 162. The ink pump 161 is connected with a second end 1632 of the first duct 163 and a second 1642 of the second duct 164. The ink pump 161 may be driven to generate a suction force. In response to the suction force, the first ink within the first ink cartridge 11 and the second ink within the second ink cartridge 12 are sucked by the ink pump 161. A first end 1651 of the first discharge pipe 165 is connected with the ink pump 161. The first discharge pipe 165 is used for discharging the first ink that is sucked by the ink pump 161. A first end 1661 of the second discharge pipe 166 is also connected with the ink pump 161. The second discharge pipe 166 is used for discharging the second ink that is sucked by the ink pump 161. The storage element 167 is connected with a second end 1652 of the first discharge pipe 165 and a second end 1662 of the second discharge pipe 166. The storage element 167 is used for storing the sucked first ink and the sucked second ink. For example, the storage element 167 is a waste ink box.

If the user finds that the first nozzle of the print head 10 has been clogged, the nozzle cleaning mechanism 16 may be enabled to have the connecting cover 162 move to a position under the print head 10 and cover the first nozzle and second nozzle. After the connecting cover 162 is coupled with the print head 10, the ink pump 161 may be driven to generate a suction force. In response to the suction force, the first ink within the first ink cartridge 11 is sucked by the ink pump 161 and transferred through the first nozzle. At the time when the first ink is transferred through the first nozzle, the dust, foreign matter or bubble within the first nozzle is flushed by the first ink, and thus the clogged condition of the first nozzle is minimized or eliminated. Then, the sucked first ink is sequentially transferred through the first duct 163, the ink pump 161 and the first discharge pipe 165, and delivered to the storage element 167 for storage. Meanwhile, the nozzle cleaning task of the print head 10 is completed. Then, the connecting cover 162 is separated from the print head 10, and the conventional inkjet printing device 1 is in a ready-to-print status.

However, during the nozzle cleaning task of the print head 10 is performed, the second ink within the second ink cartridge 12 is sucked by the ink pump 161 in response to the suction force. At the time when the second ink is transferred through the second nozzle, the dust, foreign matter or bubble within the second nozzle is flushed by the second ink, and thus the clogged condition of the second nozzle is minimized or eliminated. Then, the sucked second ink is sequentially transferred through the second duct 164, the ink pump 161 and the second discharge pipe 166, and delivered to the storage element 167 for storage. Under this circumstance, some drawbacks may occur. For example, if the second nozzle is not seriously clogged but the first nozzle is seriously clogged, after the clogged condition of the second nozzle is eliminated by the above nozzle cleaning task, the clogged condition of the first nozzle is not completely eliminated. Consequently, the ink pump 161 should be continuously operated to generate the suction force to eliminate the clogged condition of the first nozzle. Since the second nozzle is no longer clogged and the second nozzle of the print head 10 is in communication with the second ink cartridge 12 at this moment, the second ink within the second ink cartridge 12 is still sucked in response to the suction force. The way of continuously sucking the second ink may waste the ink. For saving ink, an additional ink pump may be provided to establish an independent nozzle cleaning mechanism. However, the additional ink pump increases not only the fabricating cost of the inkjet printing device but also the overall volume of the inkjet printing device.

Therefore, there is a need of providing a nozzle cleaning mechanism of an inkjet printing device for controlling the open/close statuses of different ducts.

### SUMMARY OF THE INVENTION

The present invention provides a nozzle cleaning mechanism of an inkjet printing device for controlling the open/close statuses of different ducts.

In accordance with an aspect of the present invention, there is provided a nozzle cleaning mechanism of an inkjet printing device. The nozzle cleaning mechanism is disposed within the inkjet printing device. The inkjet printing device includes a first ink cartridge for storing a first ink, a first print head connected with the first ink cartridge, a second ink cartridge for storing a second ink, a second print head connected with the second ink cartridge. The first print head has a first nozzle. The second print head has a second nozzle. The nozzle cleaning mechanism is configured for sucking the first ink or the second ink so as to eliminate a clogged condition of the first nozzle or the second nozzle. The nozzle cleaning mechanism includes an ink pump, a suction pipe, a first duct, a second duct, and a switching module. The ink pump is used for generating a suction force. The suction pipe has a first end connected with the ink pump. The first ink within the first ink cartridge is allowed to be transferred to the suction pipe through the first duct. The second duct is located beside the first duct. The second ink within the second ink cartridge is allowed to be transferred to the suction pipe through the second duct. The switching module is located near the first duct and the second duct for controlling open/close statues of the first duct and the second duct. When the first duct or the second duct is in the open status, the first ink or the second ink is transferred to the suction pipe in response to the suction force generated by the ink pump.

In an embodiment, the switching module includes a casing, a rotating shaft, a first gate mechanism, and a second gate mechanism. The rotating shaft is disposed on the casing and rotatable relative to the casing. The first gate mechanism is connected with the rotating shaft and located near the first duct. The first gate mechanism is oriented along a first direction. Upon rotation of the rotating shaft, the first duct is pressed by the first gate mechanism or separated from the first gate mechanism, so that the first duct is in the close status or the open status. The second gate mechanism is connected with the rotating shaft, located beside the first gate mechanism and located near the second duct. The second gate mechanism is oriented along a second direction. Upon rotation of the rotating shaft, the second duct is pressed by the second gate mechanism or separated from the second gate mechanism, so that the second duct is in the close status or the open status. There is an included angle between the first direction and the second direction. When the first gate mechanism is separated from the first duct, the second duct is pressed by the second gate mechanism. When the second gate mechanism is separated from the second duct, the first duct is pressed by the first gate mechanism.

In an embodiment, the first gate mechanism includes a first cam, a first contact plate, and a first elastic element. The first cam is disposed on the rotating shaft and located near the first duct. The first cam is oriented along the first direction. The first cam is rotated with the rotating shaft. The first contact plate is disposed around the first cam and the rotating shaft. When the first contact plate is not pushed by the first cam, the first duct is pressed by the first contact plate, so that the first duct is in the close status. When the first cam is rotated and the first contact plate is pushed by the first cam, the first contact plate is moved relative to the casing and separated from the first duct, so that the first duct is in the open status and the second duct is in the close status. The first elastic element is arranged between the casing and the first contact plate and contacted with the casing and the first contact plate for providing a first elastic force to the first contact plate. When the first contact plate is not pushed by the first cam, in response to the first elastic force, the first contact plate is moved relative to the casing to press the first duct.

In an embodiment, the first elastic element is a helical spring.

In an embodiment, the second gate mechanism includes a second cam, a second contact plate, and a second elastic element. The second cam is disposed on the rotating shaft and located near the second duct. The second cam is oriented along the second direction. The second cam is rotated with the rotating shaft. The second contact plate is disposed around the second cam and the rotating shaft. When the second contact plate is not pushed by the second cam, the second duct is pressed by the second contact plate, so that the second duct is in the close status. When the second cam is rotated and the second contact plate is pushed by the second cam, the second contact plate is moved relative to the casing and separated from the second duct, so that the second duct is in the open status and the first duct is in the close status. The second elastic element is arranged between the casing and the second contact plate and contacted with the casing and the second contact plate for providing a second elastic force to the second contact plate. When the second contact plate is not pushed by the second cam, in response to the second elastic force, the second contact plate is moved relative to the casing to press the second duct.

In an embodiment, the second elastic element is a helical spring.

In an embodiment, the nozzle cleaning mechanism further includes a third duct and a third gate mechanism. The third duct is located beside the second duct. A third ink within a third ink cartridge is allowed to be transferred to the suction pipe through the third duct, wherein the third ink cartridge is located beside the second ink cartridge. The third gate mechanism is connected with the rotating shaft and located near the third duct. The third gate mechanism includes a third cam, a third contact plate, and a third elastic element. The third cam is disposed on the rotating shaft and located near the third duct. The third cam is oriented along the first direction. The third cam is rotated with the rotating shaft. The third contact plate is disposed around the third cam and the rotating shaft. When the third contact plate is not pushed by the third cam, the third duct is pressed by the third contact plate, so that the third duct is in the close status. When the third cam is rotated and the third contact plate is pushed by the third cam, the third contact plate is moved relative to the casing and separated from the third duct, so that the third duct and the first duct are in the open status and the second duct is in close status. The third elastic element is arranged between the casing and the third contact plate and contacted with the casing and the third contact plate for providing a third elastic force to the third contact plate. When the third contact plate is not pushed by the third cam, in response to the third elastic force, the third contact plate is moved relative to the casing to press the third duct.

In an embodiment, the nozzle cleaning mechanism further includes a coupling element. The coupling element is arranged between the suction pipe and the first duct and the second duct. The coupling element is connected with a second end of the suction pipe, a second end of the first duct and a second end of the second duct. The coupling element includes an outlet, a first inlet, and a second inlet. The outlet is located at a first sidewall of the coupling element and connected with the second end of the suction pipe. The first inlet is located at a second sidewall of the coupling element and connected with the first duct. The first ink is introduced into the coupling element through the first inlet and transferred to the suction pipe through the outlet. The second inlet is located at the second sidewall of the coupling element, located beside the first inlet, and connected with the second duct. The second ink is introduced into the coupling element through the second inlet and transferred to the suction pipe through the outlet.

In an embodiment, the outlet, the first inlet and the second inlet are integrally formed with the coupling element.

In an embodiment, the nozzle cleaning mechanism further includes a connecting cover. The connecting cover is connected with a first end of the first duct and a first end of the second duct. The connecting cover includes a first covering recess and a second covering recess. The first covering recess is located at a top surface of the connecting cover for covering the first nozzle, so that the first ink within the first ink cartridge is introduced into the first duct through the first covering recess. The second covering recess is located at the top surface of the connecting cover and located beside the first covering recess for covering the second nozzle, so that the second ink within the second ink cartridge is introduced into the second duct through the second covering recess.

In an embodiment, the nozzle cleaning mechanism further includes a discharge pipe and a storage element. The discharge pipe has a first end connected with the ink pump. After the first ink and the second ink are transferred through the ink pump in response to the suction force, the first ink and the second ink are further transferred through the discharge pipe. The storage element is connected with a second end of the discharge pipe. After the first ink and the second ink are transferred through the discharge pipe, the first ink and the second ink are stored within the storage element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional inkjet printing device;

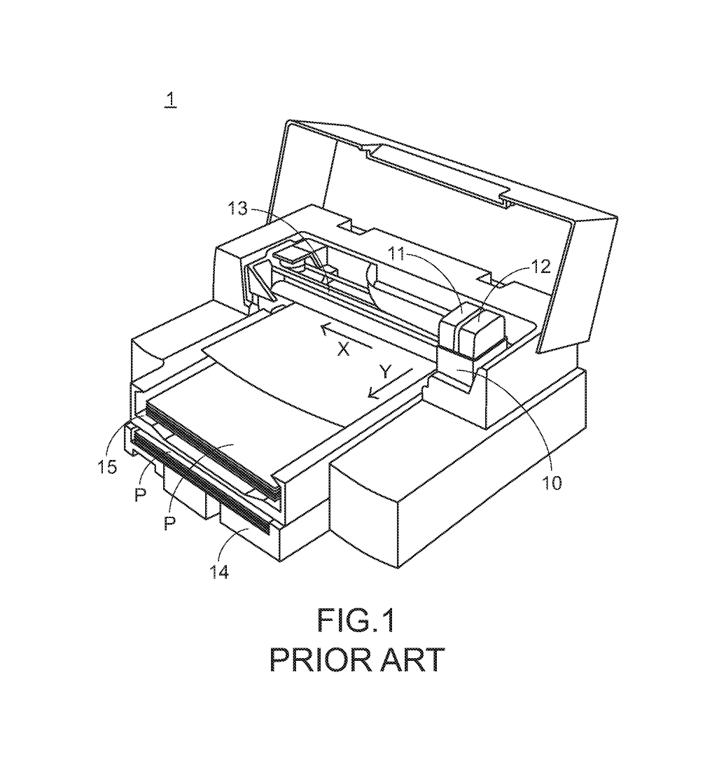

FIG. 2 is a schematic perspective view illustrating a nozzle cleaning mechanism of a conventional inkjet printing device;

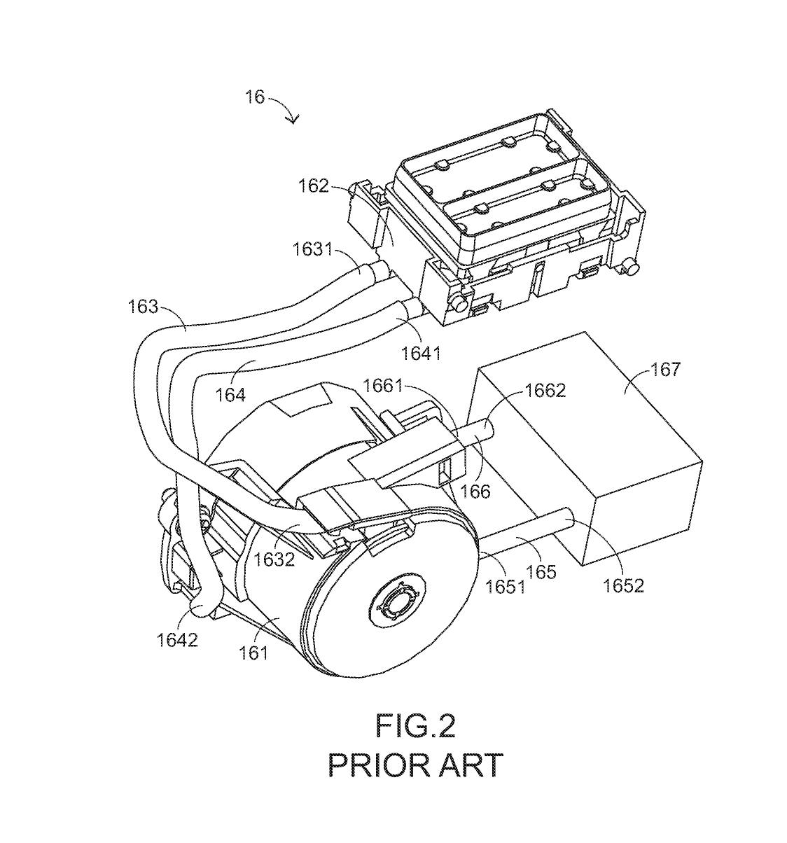

FIG. 3 is a schematic perspective view illustrating a nozzle cleaning mechanism of an inkjet printing device and a portion of the inkjet printing device according to a first embodiment of the present invention;

FIG. 4 is a schematic perspective view illustrating a portion of the nozzle cleaning mechanism of the inkjet printing device according to the first embodiment of the present invention;

FIG. 5 is a schematic perspective view illustrating the coupling element of the nozzle cleaning mechanism of the inkjet printing device according to the first embodiment of the present invention;

FIG. 6 is a schematic perspective view illustrating the switching module of the nozzle cleaning mechanism of the inkjet printing device according to the first embodiment of the present invention;

FIG. 7 is a schematic perspective view illustrating a portion of the switching module of FIG. 6;

FIG. 8 is a schematic perspective view illustrating a portion of the switching module of FIG. 6, in which the first duct is in the open status;

FIG. 9 is a schematic perspective view illustrating a portion of the switching module of FIG. 6, in which the second duct is in the open status;

FIG. 10 is a schematic perspective view illustrating a portion of the switching module of FIG. 6, in which the third duct is in the open status; and

FIG. 11 is a schematic perspective view illustrating a portion of the switching module of the nozzle cleaning mechanism of the inkjet printing device according to a second embodiment of the present invention.

### DETAILED DESCRIPTION OF THE PREFERRED EMBODIMENT

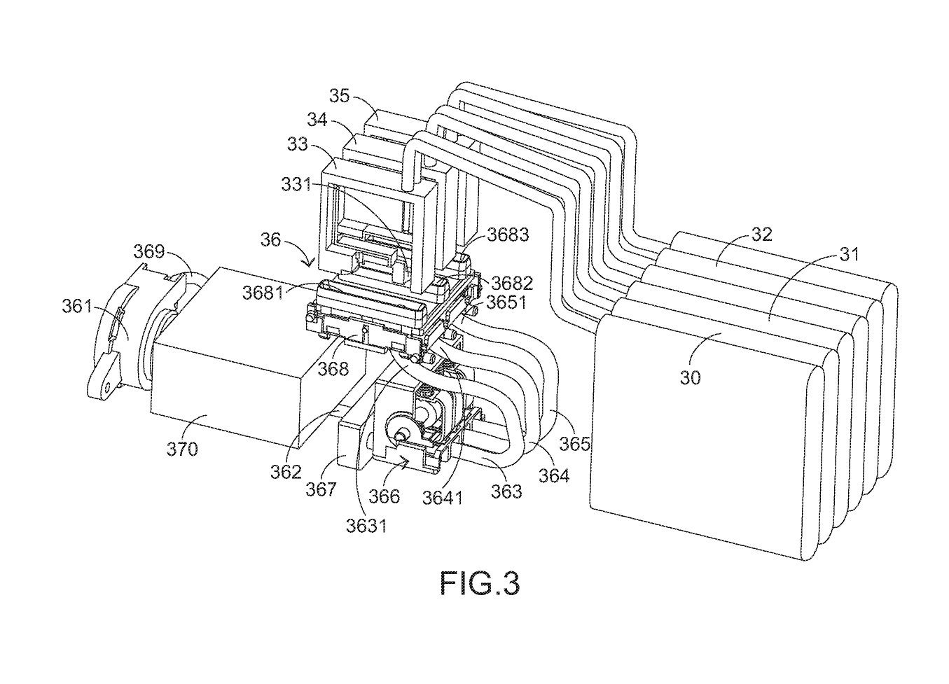

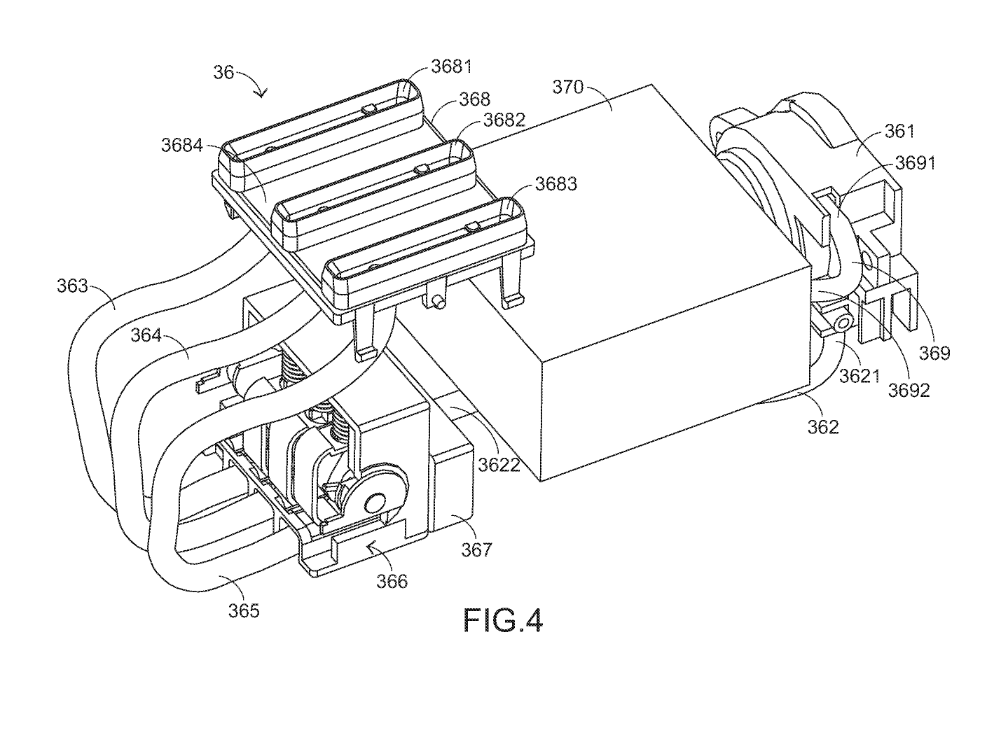

The present invention provides a nozzle cleaning mechanism of an inkjet printing device. Please refer to FIGS. 3 and 4. FIG. 3 is a schematic perspective view illustrating a nozzle cleaning mechanism of an inkjet printing device and a portion of the inkjet printing device according to a first embodiment of the present invention. FIG. 4 is a schematic perspective view illustrating a portion of the nozzle cleaning mechanism of the inkjet printing device according to the first embodiment of the present invention. In FIG. 3, only a first ink cartridge 30, a second ink cartridge 31, a third ink cartridge 32, a first print head 33, a second print head 34, a third print head 35 and a nozzle cleaning mechanism 36 of the inkjet printing device are shown, but the other components of the inkjet printing device are not shown. The first ink cartridge 30 is used for storing a first ink (not shown). The second ink cartridge 31 is located beside the first ink cartridge 30 for storing a second ink (not shown). Similarly, the third ink cartridge 32 is located beside the second ink cartridge 31 for storing a third ink (not shown). In an embodiment, the first ink is a black ink, the second ink is a color ink, and the third ink is a gray ink.

The first print head 33 is connected with the first ink cartridge 30 for ejecting the first ink. In addition, the first print head 33 has a first nozzle 331. The first ink may be transferred and ejected through the first nozzle 331. The second print head 34 is located beside the first print head 33 and connected with the second ink cartridge 31 for ejecting the second ink. In addition, the second print head 34 has a second nozzle (not shown). The second ink may be transferred and ejected through the second nozzle. The third print head 35 is located beside the second print head 34 and connected with the third ink cartridge 32 for ejecting the third ink. In addition, the third print head 35 has a third nozzle (not shown). The third ink may be transferred and ejected through the third nozzle. The structures of other components of the inkjet printing device are substantially identical to those of the conventional inkjet printing device 1, and are not redundantly described herein.

The nozzle cleaning mechanism 36 is disposed within the inkjet printing device for eliminating the clogged conditions of the first nozzle 331, the second nozzle and the third nozzle. As shown in FIG. 3, the nozzle cleaning mechanism 36 comprises an ink pump 361, a suction pipe 362, a first duct 363, a second duct 364, a third duct 365, a switching module 366, a coupling element 367, a connecting cover 368, a discharge pipe 369, and a storage element 370.

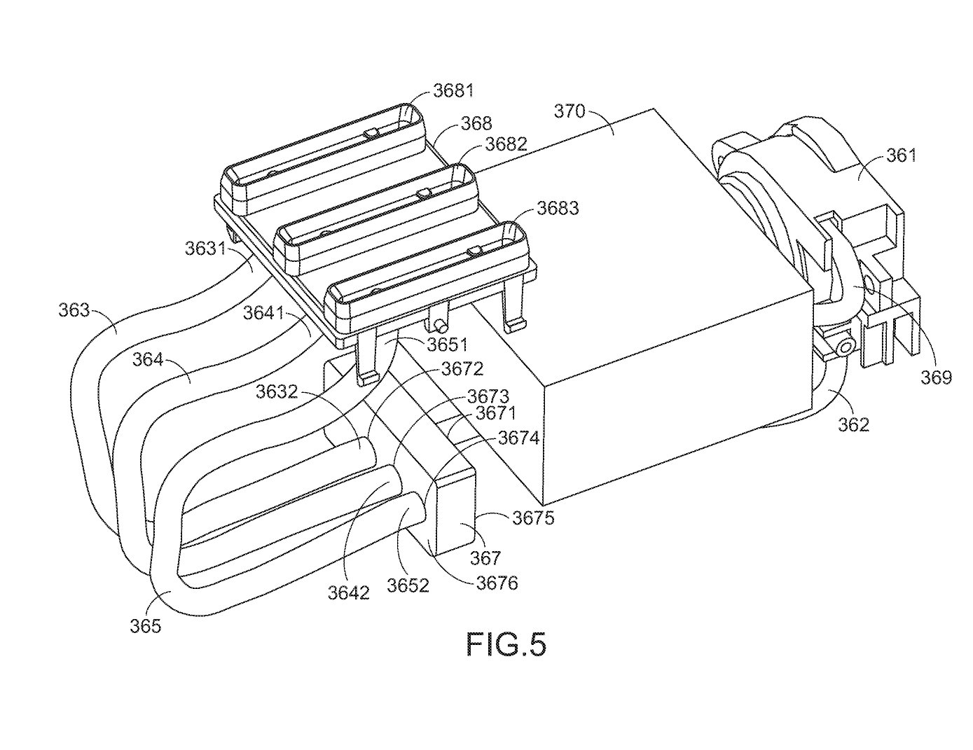

Hereinafter, the connection between associated components of the nozzle cleaning mechanism 36 will be illustrated with reference to FIGS. 3 and 4. The ink pump 361 is connected with a first end 3621 of the suction pipe 362 (see FIG. 4) and a first end 3691 of the discharge pipe 369. A second end 3692 of the discharge pipe 369 is connected with the storage element 370. A second end 3622 of the suction pipe 362 is connected with the coupling element 367. The coupling element 367 is also connected with a second end 3632 of the first duct 363 (see FIG. 5), a second end 3642 of the second duct 364 (see FIG. 5) and a second end 3652 of the third duct 365 (see FIG. 5). A first end 3631 of the first duct 363, a first end 3641 of the second duct 364 and a first end 3651 of the third duct 365 are connected with the connecting cover 368. That is, the first end 3631 of the first duct 363, the first end 3641 of the second duct 364 and the first end 3651 of the third duct 365 are respectively connected with the first print head 33, the second print head 34, the third print head 35 through the connecting cover 368. In addition, the first end 3631 of the first duct 363, the first end 3641 of the second duct 364 and the first end 3651 of the third duct 365 are located near the first print head 33, the second print head 34 and the third print head 35, respectively. The switching module 366 is located near the first duct 363, the second duct 364 and the third duct 365.

Please refer to FIGS. 3 and 4 again. The ink pump 361 is used for generating a suction force. The first end 3621 of the suction pipe 362 is connected with the ink pump 361. In response to the suction force, the pressure within the suction pipe 362 is changed. Moreover, the connecting cover 368 may be moved toward the first print head 33, the second print head 34 and the third print head 35 or moved away from the first print head 33, the second print head 34 and the third print head 35. A moving mechanism (not shown) for moving the connecting cover 368 may be enabled by the user. The connecting cover 368 is connected with the first end 3631 of the first duct 363, the first end 3641 of the second duct 364 and the first end 3651 of the third duct 365. Moreover, the connecting cover 368 comprises a first covering recess 3681, a second covering recess 3682, and a third covering recess 3683. The first covering recess 3681 is located at a top surface 3684 of the connecting cover 368 for covering the first nozzle 331 of the first print head 33. Consequently, the first ink within the first ink cartridge 30 and the first print head 33 (including the first nozzle 331) is introduced into the first duct 363 through the first covering recess 3681. The second covering recess 3682 is located at the top surface 3684 of the connecting cover 368 and located beside the first covering recess 3681 for covering the second nozzle (not shown) of the second print head 34. Consequently, the second ink within the second ink cartridge 31 and the second print head 34 (including the second nozzle) is introduced into the second duct 364 through the second covering recess 3682. The third covering recess 3683 is located at the top surface 3684 of the connecting cover 368 and located beside the second covering recess 3682 for covering the third nozzle (not shown) of the third print head 35. Consequently, the third ink within the third ink cartridge 32 and the third print head 35 (including the third nozzle) is introduced into the third duct 365 through the third covering recess 3683.

FIG. 5 is a schematic perspective view illustrating the coupling element of the nozzle cleaning mechanism of the inkjet printing device according to the first embodiment of the present invention. Please refer to FIGS. 4 and 5. The coupling element 367 is arranged between the suction pipe 362 and the three ducts 363, 364 and 365. The coupling element 367 comprises an outlet 3671, a first inlet 3672, a second inlet 3673, and a third inlet 3674. The outlet 3671 is located at a first sidewall 3675 of the coupling element 367 and connected with the second end 3622 of the suction pipe 362. The first inlet 3672 is located at a second sidewall 3676 of the coupling element 367, and connected with the first duct 363. The first ink may be introduced into the coupling element 367 through the first inlet 3672 and transferred to the suction pipe 362 through the outlet 3671. Similarly, the second inlet 3673 is located at the second sidewall 3676 of the coupling element 367, and connected with the second duct 364. The second ink may be introduced into the coupling element 367 through the second inlet 3673 and transferred to the suction pipe 362 through the outlet 3671. Similarly, the third inlet 3674 is located at the second sidewall 3676 of the coupling element 367, and connected with the third duct 365. The third ink may be introduced into the coupling element 367 through the third inlet 3674 and transferred to the suction pipe 362 through the outlet 3671. In this embodiment, the outlet 3671, the first inlet 3672, the second inlet 3673, the third inlet 3674, the first sidewall 3675 and the second sidewall 3676 are integrally formed with the coupling element 367.

From the above discussions, the first duct 363 is in communication with the first print head 33 and the ink pump 361 through the connecting cover 368 and the coupling element 367. In response to the suction force generated by the ink pump 361, the first ink within the first ink cartridge 30 may be introduced into the first print head 33 and transferred through the first nozzle 331 in order to eliminate the clogged condition of the first nozzle 331. After the first ink is separated from the first nozzle 331, in response to the suction force, the first ink is sequentially transferred through the first covering recess 3681, the first duct 363, the first inlet 3672 and the outlet 3671, and delivered to the suction pipe 362. Similarly, the second duct 364 is in communication with the second print head 34 and the ink pump 361 through the connecting cover 368 and the coupling element 367. In response to the suction force generated by the ink pump 361, the second ink within the second ink cartridge 31 may be sequentially transferred through the second print head 34, the second nozzle, the second covering recess 3682, the second duct 364, the second inlet 3673 and the outlet 3671, and delivered to the suction pipe 362. Similarly, the third duct 365 is in communication with the third print head 35 and the ink pump 361 through the connecting cover 368 and the coupling element 367. In response to the suction force generated by the ink pump 361, the third ink within the third ink cartridge 32 may be sequentially transferred through the third print head 35, the third nozzle, the third covering recess 3683, the third duct 365, the third inlet 3674 and the outlet 3671, and delivered to the suction pipe 362.

Please refer to FIGS. 4 and 5 again. The first end 3691 of the discharge pipe 369 is connected with the pump 361. After the first ink, the second ink and the third ink are transferred through the ink pump 361 in response to the suction force, the first ink, the second ink and the third ink are further transferred through the discharge pipe 369. The storage element 370 is connected with the second end of the discharge pipe 369. After the first ink, the second ink and the second ink are transferred through the discharge pipe 369, the first ink, the second ink and the third ink are stored within the storage element 370. In this embodiment, the storage element 370 is an ink-absorbing cotton. Alternatively, in some other embodiments, the storage element 370 is a waste ink cartridge or a waste ink box.

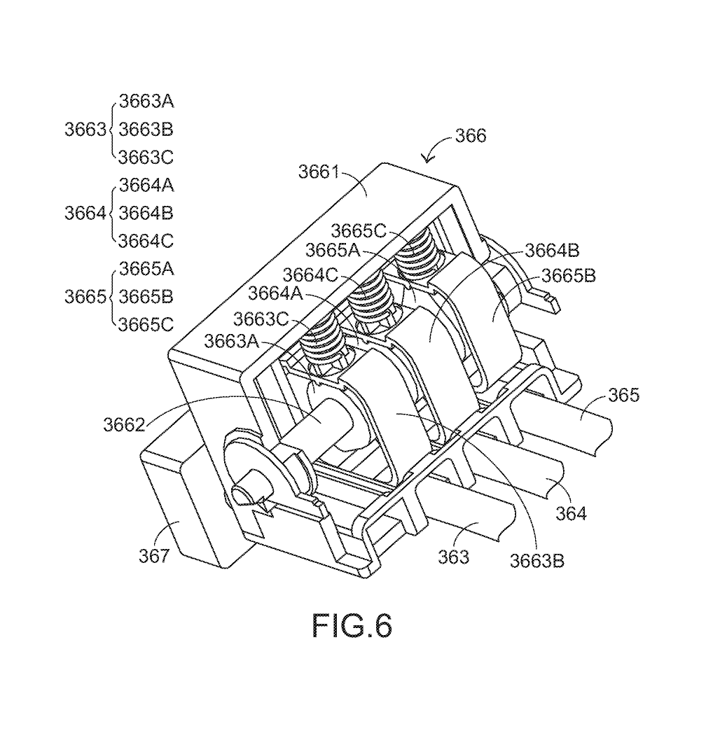

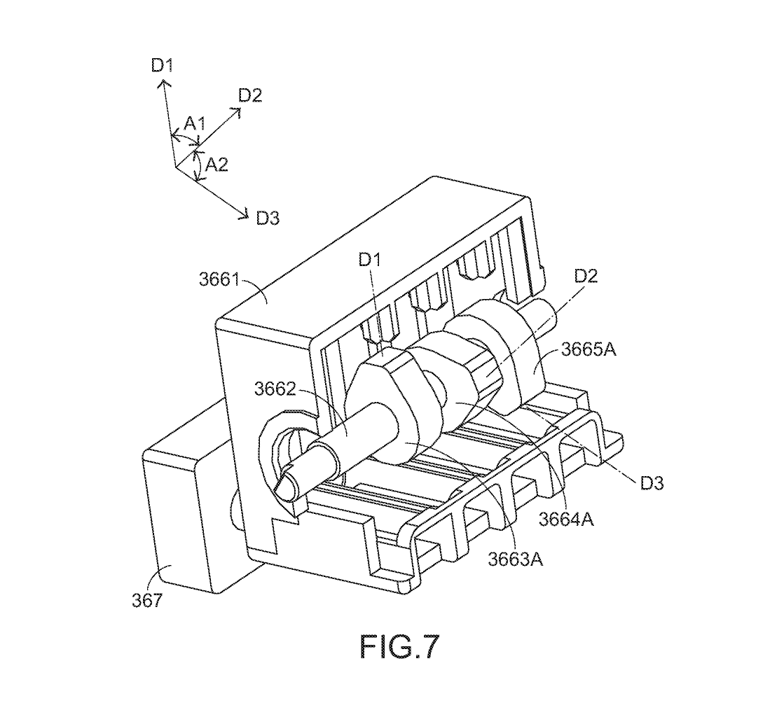

Hereinafter, the structures and operations of the switching module 366 will be illustrated with reference to FIG. 6. FIG. 6 is a schematic perspective view illustrating the switching module of the nozzle cleaning mechanism of the inkjet printing device according to the first embodiment of the present invention. The switching module 366 is located beside the first duct 363, the second duct 364 and the third duct 365. The switching module 366 is used for controlling the open/close statuses of the first duct 363, the second duct 364 and the third duct 365 in order to prevent the first ink, the second ink and the third ink from being simultaneously sucked in response to the suction force. As shown in FIG. 6, the switching module 366 comprises a casing 3661, a rotating shaft 3662, a first gate mechanism 3663, a second gate mechanism 3664, and a third gate mechanism 3665. The rotating shaft 3662 is disposed on the casing 3661, and rotatable relative to the casing 3661. The first gate mechanism 3663 is connected with the rotating shaft 3662 and located near the first duct 363. The first gate mechanism 3663 is oriented along a first direction D1 (see FIG. 7). Upon rotation of the rotating shaft 3662, the first duct 363 is pressed by the first gate mechanism 3663 or separated from the first gate mechanism 3663, so that the first duct 363 is in a close status or an open status.

The first gate mechanism 3663 comprises a first cam 3663A, a first contact plate 3663B, and a first elastic element 3663C. The first cam 3663A is disposed on the rotating shaft 3662, and located near the first duct 363. Moreover, the first cam 3663A is oriented along the first direction D1. The first cam 3663A is rotated with the rotating shaft 3662. The first contact plate 3663B is disposed around the first cam 3663A and the rotating shaft 3662. In a case that the first contact plate 3663B is not pushed by the first cam 3663A, the first duct 363 is pressed by the first contact plate 3663B, and thus the first duct 363 is in the close status. In a case that the first cam 3663A is rotated with the rotating shaft 3662 and the first contact plate 3663B is pushed by the first cam 3663A, the first contact plate 3663B is moved relative to the casing 3661 and separated from the first duct 363, and thus the first duct 363 is in the open status. The first elastic element 3663C is arranged between the casing 3661 and the first contact plate 3663B, and contacted with the casing 3661 and the first contact plate 3663B. The first elastic element 3663C is used for providing a first elastic force to the first contact plate 3663B. Once the first contact plate 3663B is not pushed by the first cam 3663A, in response to the first elastic force, the first contact plate 3663B is moved relative to the casing 3661 to press the first duct 363 and the first duct 363 is restored to the close status.

The second gate mechanism 3664 is connected with the rotating shaft 3662, and located near the second duct 364. The second gate mechanism 3664 is oriented along a second direction D2. Upon rotation of the rotating shaft 3662, the second duct 364 is pressed by the second gate mechanism 3664 or separated from the second gate mechanism 3664, so that the second duct 364 is in the close status or the open status. The second gate mechanism 3664 comprises a second cam 3664A, a second contact plate 3664B, and a second elastic element 3664C. The second cam 3664A is disposed on the rotating shaft 3662, located near the second duct 364, and located beside the first cam 3663A. Moreover, the second cam 3664A is oriented along the second direction D2. The second cam 3664A is rotated with the rotating shaft 3662. The second contact plate 3664B is disposed around the second cam 3664A and the rotating shaft 3662. In a case that the second contact plate 3664B is not pushed by the second cam 3664A, the second duct 364 is pressed by the second contact plate 3664B, and thus the second duct 364 is in the close status. In a case that the second cam 3664A is rotated with the rotating shaft 3662 and the second contact plate 3664B is pushed by the second cam 3664A, the second contact plate 3664B is moved relative to the casing 3661 and separated from the second duct 364, and thus the second duct 364 is in the open status. The second elastic element 3664C is arranged between the casing 3661 and the second contact plate 3664B, and contacted with the casing 3661 and the second contact plate 3664B. The second elastic element 3664C is used for providing a second elastic force to the second contact plate 3664B. Once the second contact plate 3664B is not pushed by the second cam 3664A, in response to the second elastic force, the second contact plate 3664B is moved relative to the casing 3661 to press the second duct 364 and the second duct 364 is restored to the close status.

The third gate mechanism 3665 is connected with the rotating shaft 3662, and located near the third duct 365. The third gate mechanism 3665 is oriented along a third direction D3. Upon rotation of the rotating shaft 3662, the third duct 365 is pressed by the third gate mechanism 3665 or separated from the third gate mechanism 3665, so that the third duct 365 is in the close status or the open status. The third gate mechanism 3665 comprises a third cam 3665A, a third contact plate 3665B, and a third elastic element 3665C. The third cam 3665A is disposed on the rotating shaft 3662, located near the third duct 365, and located beside the second cam 3664A. Moreover, the third cam 3665A is oriented along the third direction D3. The third cam 3665A is rotated with the rotating shaft 3662. The third contact plate 3665B is disposed around the third cam 3665A and the rotating shaft 3662. In a case that the third contact plate 3665B is not pushed by the third cam 3665A, the third duct 365 is pressed by the third contact plate 3665B, and thus the third duct 365 is in the close status. In a case that the third cam 3665A is rotated with the rotating shaft 3662 and the third contact plate 3665B is pushed by the third cam 3665A, the third contact plate 3665B is moved relative to the casing 3661 and separated from the third duct 365, and thus the third duct 365 is in the open status. The third elastic element 3665C is arranged between the casing 3661 and the third contact plate 3665B, and contacted with the casing 3661 and the third contact plate 3665B. The third elastic element 3665C is used for providing a third elastic force to the third contact plate 3665B. Once the third contact plate 3665B is not pushed by the third cam 3665A, in response to the third elastic force, the third contact plate 3665B is moved relative to the casing 3661 to press the third duct 365 and the third duct 365 is restored to the close status.

In this embodiment, the first elastic element 3663C, the second elastic element 3664C and the third elastic element 3665C are all helical springs.

Please refer to FIGS. 6 and 7. FIG. 7 is a schematic perspective view illustrating a portion of the switching module of FIG. 6. As shown FIG. 7, the first cam 3663A, the second cam 3664A and the third cam 3665A are arranged side by side, and disposed on the rotating shaft 3662 in a staggered form. The first cam 3663A is oriented along the first direction D1. The second cam 3664A is oriented along the second direction D2. The third cam 3665A is oriented along the third direction D3. There is a first included angle A1 between the first direction D1 and the second direction D2, and there is a second included angle A2 between the second direction D2 and the third direction D3. It is noted that the first included angle A1 and the second included angle A2 may be varied according to the practical requirements.

In a case that the first gate mechanism 3663, the second gate mechanism 3664 and the third gate mechanism 3665 of the switching module 366 are all disabled, the first duct 363, the second duct 364 and the third duct 365 are pressed by the first gate mechanism 3663, the second gate mechanism 3664 and the third gate mechanism 3665, respectively (see FIG. 4). When the first gate mechanism 3663 is separated from the first duct 363 and the first duct 363 is in the open status, the second duct 364 and the third duct 365 are respectively pressed by the second gate mechanism 3664 and the third gate mechanism 3665, so that the second duct 364 and the third duct 365 are both in the close status. Similarly, when the second gate mechanism 3664 is separated from the second duct 364 and the second duct 364 is in the open status, the first duct 363 and the third duct 365 are respectively pressed by the first gate mechanism 3663 and the third gate mechanism 3665, so that the first duct 363 and the third duct 365 are both in the close status. Similarly, when the third gate mechanism 3665 is separated from the third duct 365 and the third duct 365 is in the open status, the first duct 363 and the second duct 364 are respectively pressed by the first gate mechanism 3663 and the second gate mechanism 3664, so that the first duct 363 and the second duct 364 are both in the close status. From the above discussions, since the cams of the switching module 366 are oriented along different directions, the first duct 363, the second duct 364 and the third duct 365 are not simultaneously in the open statue under control of the switching module 366. Consequently, at the time when the nozzle cleaning task is performed, only one duct is in communication with the suction pipe 362.

The switching module 366 further comprises a driving element (not shown) and a sensing element (not shown). The driving element is connected with the rotating shaft 3662. Upon rotation of the driving element, the rotating shaft 3662 is driven to be rotated. The sensing element is located near the rotating shaft 3662 for detecting the rotating position of the rotating shaft 3662, thereby judging the operating statuses of the first gate mechanism 3663, the second gate mechanism 3664 and the third gate mechanism 3665.

The operations of the nozzle cleaning mechanism 36 of the present invention will be illustrated in more details as follows. When the user finds that the first nozzle 331 of the inkjet printing device is clogged, the user may activate the nozzle cleaning mechanism 36 to clean the first nozzle 331. After the nozzle cleaning mechanism 36 is activated, the connecting cover 368 is moved to a position under the first print head 33, the second print head 34 and the third print head 35. Then, the connecting cover 368 is moved toward the first print head 33, the second print head 34 and the third print head 35. Consequently, as shown in FIG. 3, the first nozzle 331, the second nozzle and the third nozzle are covered by the first covering recess 3681, the second covering recess 3682 and the third covering recess 3683 of the connecting cover 368, respectively.

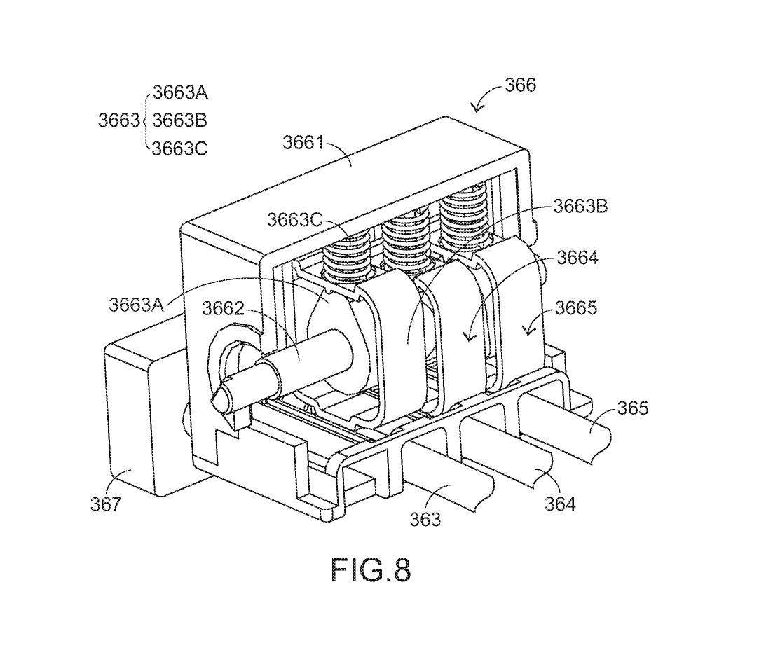

Then, the user may operate an operating interface (not shown) to enable the switching module 366 in order to rotate the rotating shaft 3662. For example, the operating interface is an operating button or a touchpad. In a case that the first cam 3663A of the first gate mechanism 3663 is rotated with the rotating shaft 3662 and rotated by a first angle, the first contact plate 3663B is pushed by the first cam 3663A and the first contact plate 3663B is moved relative to the casing 3661 in an upward direction with respect to the drawing. Since the pushing force provided by the first cam 3663A is larger than the first elastic force provided by the first elastic element 3663C, the first contact plate 3663B is separated from the first duct 363. Under this circumstance, the first duct 363 is in the open status, but the second duct 364 and the third duct 365 are both in the close status (see FIG. 8). As mentioned above, the first cam 3663A, the second cam 3664A and the third cam 3665A are arranged on the rotating shaft 3662 in the staggered form. Consequently, at the time when the first contact plate 3663B is pushed by the first cam 3663A, the second contact plate 3664B and the third contact plate 3665B are not pushed by the second cam 3664A and the third cam 3665A, respectively.

Then, the user may further operate the operating interface to turn on the ink pump 361. Consequently, a suction force is generated within the suction pipe 362, which is connected with the ink pump 361. Since the first duct 363 is in the open status, the regions between the suction pipe 362 and the first pint head 33 covered by the first covering recess 3681 are in communication with each other. Moreover, in response to the suction force, the first ink within the first ink cartridge 30 is transferred to the ink pump 361 through the first pint head 33, the first nozzle 331, the first covering recess 3681, the first duct 363, the first inlet 3672, the outlet 3671 and the suction pipe 362 sequentially. Afterwards, the sucked first ink is discharged to the discharge pipe 369 by the ink pump 361, and transferred to the storage element 370. After the nozzle cleaning task of the first nozzle 331 is competed, the ink pump 361 is turned off by the user, and thus the suction force is no longer generated. Then, the rotating shaft 3662 of the switching module 366 is controlled to be rotated by an angle to a position where the first duct 363, the second duct 364 and the third duct 365 are all in the close status (see FIG. 4).

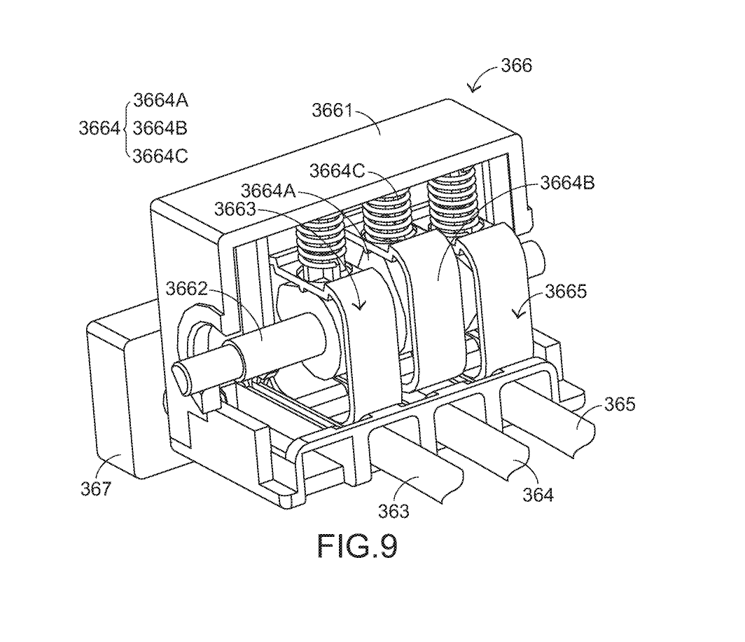

In a case that the user wants to eliminate the clogged condition of the second nozzle, the above process may be performed to allow the first nozzle 331, the second nozzle and the third nozzle to be covered by the first covering recess 3681, the second covering recess 3682 and the third covering recess 3683 of the connecting cover 368, respectively. Then, the user may utilize the operating interface to enable the switching module 366 in order to rotate the rotating shaft 3662. In a case that the second cam 3664A is rotated with the rotating shaft 3662 and rotated to a position where the second contact plate 3664B is pushed by the second cam 3664A, the second contact plate 3664B is moved relative to the casing 3661 in an upward direction with respect to the drawing. Since the pushing force provided by the second cam 3664A is larger than the second elastic force provided by the second elastic element 3664C, the second contact plate 3664B is separated from the second duct 364. Under this circumstance, the second duct 364 is in the open status, but the first duct 363 and the third duct 365 are both in the close status (see FIG. 9).

Then, the user may turn on the ink pump 361 to generate the suction force. In response to the suction force, the second ink within the second ink cartridge 31 is transferred to the ink pump 361 through the second print head 34, the second nozzle, the second covering recess 3682, the second duct 364, the second inlet 3673, the outlet 3671 and the suction pipe 362 sequentially. Afterwards, the sucked second ink is discharged to the discharge pipe 369 by the ink pump 361, and transferred to the storage element 370. After the nozzle cleaning task of the second nozzle is competed, the ink pump 361 is turned off by the user, and thus the suction force is no longer generated. Then, the rotating shaft 3662 of the switching module 366 is controlled to be rotated by an angle to a position where the first duct 363, the second duct 364 and the third duct 365 are all in the close status.

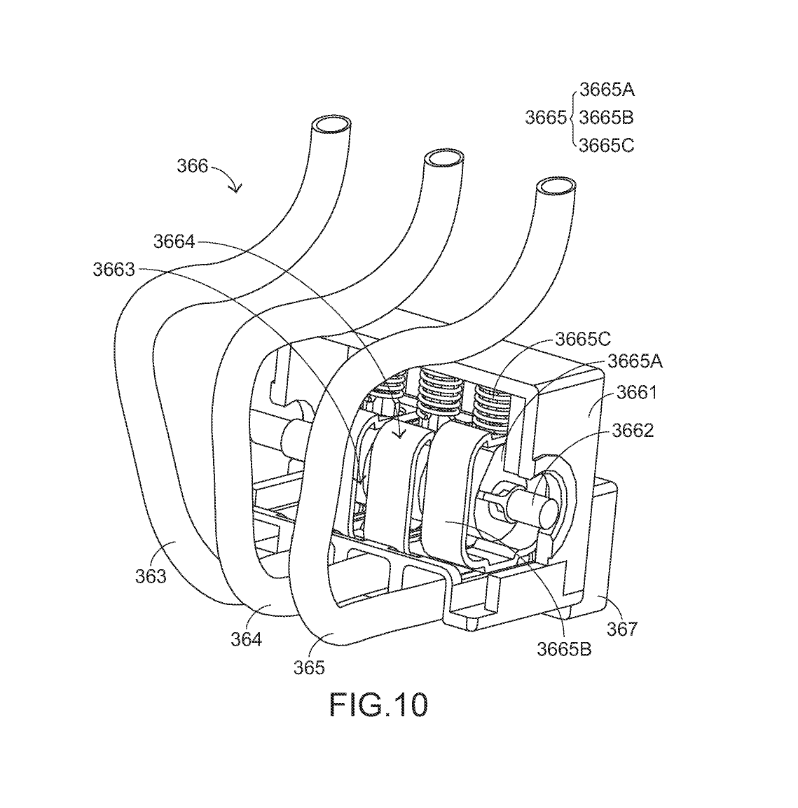

In a case that the user wants to eliminate the clogged condition of the third nozzle, the above process may be performed to allow the first nozzle 331, the second nozzle and the third nozzle to be covered by the first covering recess 3681, the second covering recess 3682 and the third covering recess 3683 of the connecting cover 368, respectively. Then, the user may utilize the operating interface to enable the switching module 366 in order to rotate the rotating shaft 3662. In a case that the third cam 3665A is rotated with the rotating shaft 3662 and rotated to a position where the third contact plate 3665B is pushed by the third cam 3665A, the third contact plate 3665B is moved relative to the casing 3661 in an upward direction with respect to the drawing. Since the pushing force provided by the third cam 3665A is larger than the third elastic force provided by the third elastic element 3665C, the third contact plate 3665B is separated from the third duct 365. Under this circumstance, the third duct 365 is in the open status, but the first duct 363 and second duct 364 are both in the close status (see FIG. 10).

Then, the user may turn on the ink pump 361 to generate the suction force. In response to the suction force, the third ink within the third ink cartridge 32 is transferred to the ink pump 361 through the third pint head 35, the third nozzle, the third covering recess 3683, the third duct 365, the third inlet 3674, the outlet 3671 and the suction pipe 362 sequentially. Afterwards, the sucked third ink is discharged to the discharge pipe 369 by the ink pump 361, and transferred to the storage element 370. After the nozzle cleaning task of the third nozzle is competed, the ink pump 361 is turned off by the user, and thus the suction force is no longer generated. Then, the rotating shaft 3662 of the switching module 366 is controlled to be rotated by an angle to a position where the first duct 363, the second duct 364 and the third duct 365 are all in the close status.

In this embodiment, according to the preset settings, after the clogged conditions of the first nozzle 331, the second nozzle and the third nozzle are eliminated by the first ink, the second ink and the third ink that are transferred therethrough, the switching module 366 will control all of the first duct 363, the second duct 364 and the third duct 365 to be switched to the close status. Alternatively, in some other embodiments, according to the preset settings, the switching module may control all of the first duct, the second duct and the third duct to be switched to the open status.

In this embodiment, the nozzle cleaning mechanism 36 is applied to the inkjet printing device with three ink cartridges, and thus the switching module 366 of the nozzle cleaning mechanism 36 comprises three gate mechanisms. It is noted that the nozzle cleaning mechanism of the present invention may be applied to the inkjet printing device with another number of ink cartridges according to the practical requirements. For example, the nozzle cleaning mechanism of the present invention may be applied to the inkjet printing device with only a black ink cartridge and a color ink cartridge, and thus the switching module of the nozzle cleaning mechanism comprises two gate mechanisms. Alternatively, the nozzle cleaning mechanism of the present invention may be applied to the inkjet printing device with four ink cartridges (i.e. a cyan (C) ink cartridge, a magenta (M) ink cartridge, a yellow (Y) ink cartridge and a black (K) ink cartridge), and thus the switching module of the nozzle cleaning mechanism comprises four gate mechanisms.

From the above discussions, the nozzle cleaning mechanism of the inkjet printing device of this embodiment utilizes the switching module to simultaneously press the first duct and the second duct. Moreover, the first gate mechanism and the second gate mechanism of the switching module are arranged side by side and in a staggered form. For cleaning the first nozzle, the switching module may be enabled to allow the first duct which is in communication with the first nozzle to be in the open status and allow the second duct to be in the close state. For cleaning the second nozzle, the switching module may be enabled to allow the second duct which is in communication with the second nozzle to be in the open status and allow the first duct to be in the close state. Since the nozzle which is unneeded to be cleaned is not influenced by the suction force of the ink pump, the purpose of saving ink is achieved.

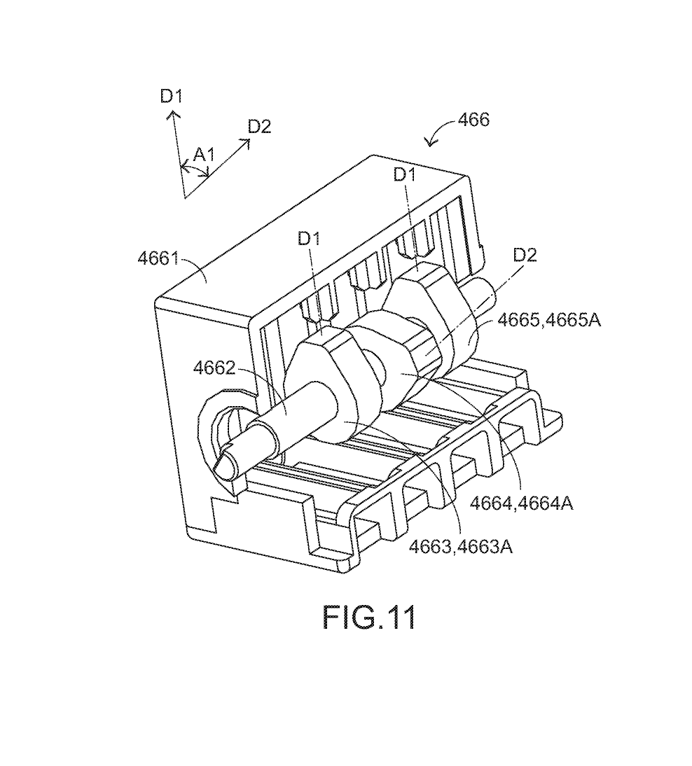

The present invention further provides a second embodiment of a nozzle cleaning mechanism. Except for the switching module, the structures of the nozzle cleaning mechanism of the second embodiment are substantially identical to those of the first embodiment. FIG. 11 is a schematic perspective view illustrating a portion of the switching module of the nozzle cleaning mechanism of the inkjet printing device according to a second embodiment of the present invention. In FIG. 11, only the switching module 466 is shown. The other components of the nozzle cleaning mechanism of the second embodiment are identical to those of the first embodiment, and are not redundantly described herein. As shown in FIG. 11, the switching module 466 comprises a casing 4661, a rotating shaft 4662, a first gate mechanism 4663, a second gate mechanism 4664, and a third gate mechanism 4665. The rotating shaft 4662 is disposed on the casing 4661, and rotatable relative to the casing 4661. A first cam 4663A of the first gate mechanism 4663 is disposed on the rotating shaft 4662, and located near the first duct (not shown). The first cam 4663A is oriented along a first direction D1. In addition, the first cam 4663A is rotated with the rotating shaft 4662.

A second cam 4664A of the second gate mechanism 4664 is disposed on the rotating shaft 4662, and located near the second duct (not shown). The second cam 4664A is oriented along a second direction D2. In addition, the second cam 4664A is rotated with the rotating shaft 4662. A third cam 4665A of the third gate mechanism 4665 is disposed on the rotating shaft 4662, and located near the third duct (not shown). The third cam 4665A is also oriented along the first direction D1. In addition, the third cam 4665A is rotated with the rotating shaft 4662. In other words, the first cam 4663A and the third cam 4665A are oriented along the same direction, so that the first gate mechanism 4663 and the third gate mechanism 4665 are synchronously operated. After the switching module 466 is enabled, the first duct is not pressed by the first gate mechanism 4663, so that the first duct is in the open status; the second duct is pressed by the second gate mechanism 4664, so that the second duct is in the close status; and the third duct is not pressed by the third gate mechanism 4665, so that the third duct is also in the open status.

From the above discussions, the nozzle cleaning mechanism of the inkjet printing device of this embodiment utilizes the switching module to control the open/close statuses of the first duct, the second duct and the third duct. Since the first gate mechanism and the third gate mechanism are synchronously operated, after the switching module is enabled, the first duct and the third duct are simultaneously in communication with the suction pipe, so that the first nozzle and the third nozzle can be cleaned but the second duct is in the close status; and vice versa. That is, in the nozzle cleaning mechanism of the inkjet printing device of this embodiment, the orientation directions of the cams may be varied according to the practical requirements in order to control the operations of the switching module.

From the above descriptions, the present invention provides a nozzle cleaning mechanism of an inkjet printing device. The nozzle cleaning mechanism of the inkjet printing device may open the first duct and the second duct in order to clean the first nozzle and the second nozzle, respectively. In a case that one of the nozzles does not need to be cleaned, the duct in communication with this nozzle is not influenced by the ink pump, and thus the purpose of saving ink is achieved. Moreover, in the nozzle cleaning mechanism of the inkjet printing device of the present invention, the orientation directions of the cams may be varied according to the practical requirements in order to control a specified number of ducts to be in the open status or control a specified number of ducts to be in the close status. Moreover, the nozzle cleaning mechanism of the inkjet printing device of the present invention is capable of cleaning different nozzles without the need of installing an additional ink pump. Consequently, the overall volume of the inkjet printing device is not increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A nozzle cleaning mechanism of an inkjet printing device, said nozzle cleaning mechanism being disposed within said inkjet printing device, said inkjet printing device comprising a first ink cartridge for storing a first ink, a first print head connected with said first ink cartridge, a second ink cartridge for storing a second ink, a second print head connected with said second ink cartridge, said first print head having a first nozzle, said second print head having a second nozzle, said nozzle cleaning mechanism being configured for sucking said first ink or said second ink so as to eliminate a clogged condition of said first nozzle or said second nozzle, said nozzle cleaning mechanism comprising:
an ink pump for generating a suction force;
a suction pipe having a first end connected with said ink pump;
a first duct, wherein said first ink within said first ink cartridge is allowed to be transferred to said suction pipe through said first duct;
a second duct located beside said first duct, wherein said second ink within said second ink cartridge is allowed to be transferred to said suction pipe through said second duct; and
a switching module located near said first duct and said second duct for controlling open/close statues of said first duct and said second duct, wherein when said first duct or said second duct is in said open status, said first ink or said second ink is transferred to said suction pipe in response to said suction force generated by said ink pump.

2. The nozzle cleaning mechanism according to claim 1, wherein said switching module comprises:
a casing;
a rotating shaft disposed on said casing and rotatable relative to said casing;
a first gate mechanism connected with said rotating shaft and located near said first duct, wherein said first gate mechanism is oriented along a first direction, wherein upon rotation of said rotating shaft, said first duct is pressed by said first gate mechanism or separated from said first gate mechanism, so that said first duct is in said close status or said open status; and
a second gate mechanism connected with said rotating shaft, located beside said first gate mechanism, and located near said second duct, wherein said second gate mechanism is oriented along a second direction, wherein upon rotation of said rotating shaft, said second duct is pressed by said second gate mechanism or separated from said second gate mechanism, so that said second duct is in said close status or said open status, wherein there is an included angle between said first direction and said second direction, wherein when said first gate mechanism is separated from said first duct, said second duct is pressed by said second gate mechanism, wherein when said second gate mechanism is separated from said second duct, said first duct is pressed by said first gate mechanism.

3. The nozzle cleaning mechanism according to claim 2, wherein said first gate mechanism comprises:
a first cam disposed on said rotating shaft and located near said first duct, wherein said first cam is oriented along said first direction, and said first cam is rotated with said rotating shaft;
a first contact plate disposed around said first cam and said rotating shaft, wherein when said first contact plate is not pushed by said first cam, said first duct is pressed by said first contact plate, so that said first duct is in said close status, wherein when said first cam is rotated and said first contact plate is pushed by said first cam, said first contact plate is moved relative to said casing and separated from said first duct, so that said first duct is in said open status and said second duct is in said close status; and
a first elastic element arranged between said casing and said first contact plate and contacted with said casing and said first contact plate for providing a first elastic force to said first contact plate, wherein when said first contact plate is not pushed by said first cam, in response to said first elastic force, said first contact plate is moved relative to said casing to press said first duct.

4. The nozzle cleaning mechanism according to claim 3, wherein said first elastic element is a helical spring.

5. The nozzle cleaning mechanism according to claim 2, wherein said second gate mechanism comprises:
a second cam disposed on said rotating shaft and located near said second duct, wherein said second cam is oriented along said second direction, and said second cam is rotated with said rotating shaft;
a second contact plate disposed around said second cam and said rotating shaft, wherein when said second contact plate is not pushed by said second cam, said second duct is pressed by said second contact plate, so that said second duct is in said close status, wherein when said second cam is rotated and said second contact plate is pushed by said second cam, said second contact plate is moved relative to said casing and separated from said second duct, so that said second duct is in said open status and said first duct is in said close status; and
a second elastic element arranged between said casing and said second contact plate and contacted with said casing and said second contact plate for providing a second elastic force to said second contact plate, wherein when said second contact plate is not pushed by said second cam, in response to said second elastic force, said second contact plate is moved relative to said casing to press said second duct.

6. The nozzle cleaning mechanism according to claim 5, wherein said second elastic element is a helical spring.

7. The nozzle cleaning mechanism according to claim 2, further comprising:
a third duct located beside said second duct, wherein a third ink within a third ink cartridge is allowed to be transferred to said suction pipe through said third duct, wherein said third ink cartridge is located beside said second ink cartridge; and
a third gate mechanism connected with said rotating shaft and located near said third duct, wherein said third gate mechanism comprises:
a third cam disposed on said rotating shaft and located near said third duct, wherein said third cam is oriented along said first direction, and said third cam is rotated with said rotating shaft;
a third contact plate disposed around said third cam and said rotating shaft, wherein when said third contact plate is not pushed by said third cam, said third duct is pressed by said third contact plate, so that said third duct is in said close status, wherein when said third cam is rotated and said third contact plate is pushed by said third cam, said third contact plate is moved relative to said casing and separated from said third duct, so that said third duct and said first duct are in said open status and said second duct is in close status; and
a third elastic element arranged between said casing and said third contact plate and contacted with said casing and said third contact plate for providing a third elastic force to said third contact plate, wherein when said third contact plate is not pushed by said third cam, in response to said third elastic force, said third contact plate is moved relative to said casing to press said third duct.

8. The nozzle cleaning mechanism according to claim 1, further comprising a coupling element, wherein said coupling element is arranged between said suction pipe and said first duct and said second duct, and said coupling element is connected with a second end of said suction pipe, a second end of said first duct and a second end of said second duct, wherein said coupling element comprises:
an outlet located at a first sidewall of said coupling element and connected with said second end of said suction pipe;
a first inlet located at a second sidewall of said coupling element and connected with said first duct, wherein said first ink is introduced into said coupling element through said first inlet and transferred to said suction pipe through said outlet; and
a second inlet located at said second sidewall of said coupling element, located beside said first inlet, and connected with said second duct, wherein said second ink is introduced into said coupling element through said second inlet and transferred to said suction pipe through said outlet.

9. The nozzle cleaning mechanism according to claim 8, wherein said outlet, said first inlet and said second inlet are integrally formed with said coupling element.

10. The nozzle cleaning mechanism according to claim 1, further comprising a connecting cover, wherein said connecting cover is connected with a first end of said first duct and a first end of said second duct, wherein said connecting cover comprises:
a first covering recess located at a top surface of said connecting cover for covering said first nozzle, so that said first ink within said first ink cartridge is introduced into said first duct through said first covering recess; and
a second covering recess located at said top surface of said connecting cover and located beside said first covering recess for covering said second nozzle, so that said second ink within said second ink cartridge is introduced into said second duct through said second covering recess.

11. The nozzle cleaning mechanism according to claim 1, further comprising:
a discharge pipe having a first end connected with said ink pump, wherein after said first ink and said second ink are transferred through said ink pump in response to said suction force, said first ink and said second ink are further transferred through said discharge pipe; and
a storage element connected with a second end of said discharge pipe, wherein after said first ink and said second ink are transferred through said discharge pipe, said first ink and said second ink are stored within said storage element.
